(19) United States
(12) Patent Application Publication
(10) Pub. No.: US 2010/0034631 A1
(43) Pub. Date: Feb. 11, 2010

(54) METHOD FOR CONVEYING OBJECTS

(75) Inventors: Franz Klaiber, Wehingen (DE); Peter Novak, Tagerwilen (CH)

Correspondence Address: BACHMAN & LAPOINTE, P.C., 900 CHAPEL STREET, SUITE 1201, NEW HAVEN, CT, 06510, US

(73) Assignee: NOV HAU AG ENGINEERING, Tagerwilen (CH)

(21) Appl. No.: 12/516,839

(22) PCT Filed: Nov. 23, 2007
(86) PCT No.: PCT/EP2007/010203

§ 371 Date: Oct. 27, 2009

(30) Foreign Application Priority Data
Nov. 30, 2006 (DE) 10 2006 056 943.1
Dec. 21, 2006 (DE) 10 2006 061 993.5

(51) Int. Cl. B65G 9/00

(52) U.S. Cl. 414/751.1; 414/800; 414/749.1

(57) ABSTRACT

A method for conveying especially light objects (23, 23.1), particularly empty or full PET bottles. In the method, the object (23, 23.1) is accepted between two claws (5, 6) of claw arms (3.1, 3.2) of a griping vehicle (2, 2.1, 2.2, 2.3, 2.4) which moves along a rail (1, 1.1, 1.2).

### BACKGROUND OF THE INVENTION

The invention relates to a method for conveying in particular light objects, in particular empty or full PET bottles, wherein the object is received between two grippers by a scissors-like opening movement of the two gripping arms of a gripper vehicle which moves along a rail.

In many branches of industry an object has to be conveyed from one processing station to the next or to a packaging station or the like. The present invention is concerned with all objects, in particular with those having an opening, regardless of type, and a neck ring, regardless of configuration. It is concerned above all with PET containers. The PET industry is a highly technologized area of operation of the packaging industry and is enjoying enormous growth, since the advantages of PET containers are obvious. PET bottles are produced in all possible shapes, sizes and colors in complicated steps. To this end, as a rule, first of all preforms are produced which are then supplied, optionally through cooling and/or heating sections, to a stretch blow molding machine. The preforms are then provided with the shape of the PET bottle in said stretch blow molding machine. Said PET bottle then has to be conveyed further for labeling, filling and closing and for packaging and/or palletizing. In this case, empty bottles are predominantly conveyed by means of air flow. In this type of conveying, the bottles are placed by the neck ring on sliding rails and conveyed with the aid of accelerated air. This method is highly energy-intensive and causes high operating costs. Furthermore, a large amount of filtered air has to be consumed. A further disadvantage is the flexibility of the system, since the conversion from one type of bottle to another (change of format because of differing head diameter) can be undertaken only with a large amount of time or outlay on automation. For this reason, two parallel conveying sections of several hundred meters in length often have to be installed.

In the case of the known systems, the objects, namely PET bottles, are generally grasped at their neck by a gripping device and conveyed in a generally horizontal position. The gripping devices in this case are located on a chain composed of fixedly connected links. In this case, enormous forces act on the system which is also subject to a large amount of wear. The speed of the system is limited and there is no backing-up option.

Reference is made in this connection to U.S. Pat. No. 2,796,181. A method and an apparatus for conveying in particular light objects is likewise shown there, with the object being held between two grippers of gripping arms of a gripping vehicle which moves along a rail.

It is the object of the present invention to substantially simplify and reduce the cost of conveying empty and full objects with an opening and a neck ring, in particular the conveying of PET bottles, and to design the conveying in a manner such that it can be traced and such that it is reliable, and to develop an apparatus with which handling of the objects which are to be conveyed is designed to be highly flexible.

### SUMMARY OF THE INVENTION

The object is achieved in that the scissors-like opening movement is brought about by the rail.

This invention results in a two-part gripping device, wherein one gripper, namely the inner gripper, is lowered into the bottle opening during the transfer of the bottle while a second gripper, namely the outer gripper, acts on the object from the outside below the neck ring and therefore the object is secured against slipping vertically after the gripping device is closed.

For this purpose, in a preferred exemplary embodiment, the gripper vehicle is essentially constructed with two limbs as per a pair of scissors. The two gripping arms are connected to each other by a rotary spindle in the manner of a pair of scissors, with it optionally also being possible to provide a closing spring which is fastened to one gripping arm and presses the object against the other gripping arm or gripper. By this means, the object is additionally stabilized during the conveying. This and the conveying securing means described further on ensure that the gripping device does not open even upon a jerky, sudden stopping of the gripper vehicle. The object which is to be conveyed is held in a secured manner. Furthermore, the object can be conveyed in any position in space, i.e. even horizontally or upside down. This signifies a considerable degree of flexibility in the guiding of the object from one processing station to the other.

The two gripping arms are preferably essentially designed as limb-like flat components such that the one gripping arm which forms the entire back wall of the gripper vehicle can also be referred to as the basic limb and the other gripping arm can be referred to as the scissor limb. For example, the outer gripper is located on the basic limb and the inner gripper on the scissor limb. However, other arrangements covered by the invention are also conceivable here. For example, an externally actuable gripper can be arranged on a rigid gripper vehicle.

The invention pays particular attention to the automation of transferring the objects. For this purpose, elements on the gripper vehicle interact with the rail. The rail preferably comprises a simple flat material strip which has a certain height. If said height is changed, an opening movement of the two gripping arms will occur. In a preferred exemplary embodiment of the invention, this takes place by three rollers being arranged on the gripper vehicle. One roller which runs along the upper edge of the rail sits substantially on the rotary spindle of the basic limb and scissor limb. A further roller which is connected to the basic limb runs along a lower edge of the rail, and a third roller, which likewise runs along the lower edge of the rail, is connected to the scissor limb. In this context, the rotary spindles of the three rollers form a triangle with one another. If the height of the rail is changed, an opening movement of the gripping arms occurs, since the distance between the rollers running along the lower edge of the rail changes. If the height of the rail is then reduced again, the distance between the rotary spindles of the two rollers running along the lower edge of the rail increases, and a closing of the gripping device occurs, optionally with the assistance of the above-mentioned closing spring, i.e. a clamping interaction of the outer gripper and inner gripper occurs.

It is important in said sequence of movement that the actual moving rail is at the same time also the contour for the actuation/movement of the two gripping arms. Therefore, a further curved rail (switching guide way) is not required in order to produce a sequence of movement of the grippers.

In a preferred embodiment, the gripper vehicle is also to be assigned a conveying securing means, i.e. a securing means which ensures that the gripping arms do not permit any undesirable opening movement during the normal conveying of the object. The above-mentioned closing spring does indeed already play a highly effective role in ensuring that the objects are secured between the grippers. However, because of accelerations triggered by changes in speed or centrifugal forces, it is possible, in particular in the case of long objects, such as PET bottles, that the gripping device may open, i.e. that the force of the closing spring does not suffice to absorb the moments which occur. If, however, the two moveable limbs, namely the basic limb and scissor limb, are fixed during the journey, said fixing (locking) receives the moments which occur, and the object cannot be detached from the gripping device. In a simple exemplary embodiment, the basic limb and scissor limb are fixed by a ball. The ball is pressed on one side by a leaf spring through an opening in the basic limb against a seat surface in the scissor limb. The seat surface circumscribes a diameter which is smaller that the diameter of the ball. By contrast, the opening in the basic limb has a somewhat larger diameter than that of the ball. The ball is therefore now held neatly in position on the seat surface and locks the two limbs against each other.

In order now to be able to open the grippers, the gripping arms have to be released. This means that the ball has to be moved from its locking position. This takes place by means of a switching guide way which is provided, for example, on the rail and presses the ball to the outside counter to the spring force of the leaf spring. Since the opening of the scissor limb is provided with a tangential edge by the formation of a bevel which at the same time also forms the above-mentioned seat surface, during an opening movement of the gripping arms counter to each other said tangential edge now slides along the ball and presses the ball entirely out of the opening in the scissor limb. The two limbs are therefore released and can carry out the required opening and closing movements.

This type of locking is highly efficient and results in virtually no frictional forces during the unlocking.

Each gripper vehicle is preferably also to be assigned an identification feature. This may be, for example, a barcode which is fastened or attached to the vehicle or, if need be, a data matrix code. Reading stations installed in the system permit conclusions to be made about the position of each vehicle or each object. Since, according to the present invention, each object is conveyed individually by a dedicated gripper vehicle, it is also possible to identify each individual object via the coded vehicle. Said identification gives rise to the possibility, for example, of removing defective objects anywhere in the system from circulation. However, for example, different types of bottles could also be conveyed or stored on the same system and then, owing to vehicle identification, could be separated again from one another at a suitable location. Said vehicle identification furthermore also permits the individual identification of the moving time/running time of each individual vehicle, which, in turn, permits conclusions to be made about the wear. This is a prerequisite for preventative maintenance. The use of individual identification is entirely new in the PET packaging industry.

A further feature of the present invention, which feature is preferably used, is concerned with the fact that a plurality of gripper vehicles can be coupled together. Particularly in curves in which, for example for cost reasons, there is no drive by means of a belt or the like, it is highly useful to couple individual vehicles to one another and therefore to push or pull the vehicles through the curves which are not covered by the belt drive. In the case of a drive-free curve, the rearmost, still driven vehicles of an arrangement push the front vehicles through the curve until the frontmost vehicles are again picked up by the drive and driven so that they pull the rear vehicles after them through the curve.

In a simple exemplary embodiment, the coupling takes place with the aid of a magnet which interacts with a spring of the front vehicle. The use of a spring also has the advantage that, when one vehicle collides with the next one, blows and impacts are substantially cushioned.

PET bottles in particular should remain clean during conveying and storage and prior to filling, i.e. no extraneous particles should be deposited in the interior of the bottle. A cover is therefore provided on the gripper vehicle, said cover taking over the covering of the opening in the object to be conveyed and catching the dirt which arises. In the case of special objects in the “aseptic sphere”, it may even be necessary to completely seal an object (bottle) during the conveying. This may take place by means of a stopper which is assigned to the inner gripper. During the picking up of a bottle, said stopper is lowered into the opening such that the opening is completely closed and the interior of the bottle is protected from external influences.

Furthermore, it has proven advisable to design the cover to be flexible such that it can yield to a pressure exerted by, for example, a PET container when said PET container is picked up. The cover is therefore preferably supported against a helical spring.

The rails in particular will now be referred to once again. As mentioned above, the rail involves a conventional rectangular profile. Said profile affords many advantages. The manufacturing of the profile is very simple and cost-effective, which is very worthwhile in the case of section lengths of sometimes several hundred meters. The rectangular profile can be bent with little effort into the desired shape, and therefore arcs or else spirals can be realized in a simple manner. Owing to the shape of the profile, the position of the vehicles is unambiguously defined, and even torques which are produced by the system or the vehicles can be absorbed via the profile.

In order also effectively to use the advantages produced by the individual conveying and the individual vehicle identification, the system preferably has to have switches which permit separations. If switches are present in a system, this opens up the possibility of opening the system, i.e. it does not inevitably have to be a closed circuit.

A particular advantage of the present invention is the simple configuration of a switch, which is possible owing to the above-mentioned profile. Rapid switching times of the switches are of enormous significance in order to achieve a highly dynamic and energy-saving system which is as efficient as possible. Switching times are directly linked with the switching distance which has to be overcome, and therefore small switching distances are particularly important. The vehicle according to the present invention is constructed such that it is as slender as possible in the region in which interaction with the switch can take place so as to reduce the switching distance required to a minimum.

The switch preferably comprises merely one rail strip which is connected to the actual rail. The switch is moved from one to the other rail guide depending on which rail guide the gripper vehicle is to be deflected. This can take place by means of a simple pneumatic drive or with a lifting magnet. So that rails or switches of differing thickness are not used for the gripper vehicle, it may prove advisable to reduce the thickness of the rails and rail guides and the switch in the connecting region such that addition of the thicknesses of the connecting regions does not exceed the actual thickness of the rail. Instead of the regions of reduced thickness, just one stop may also be provided.

In a first variant according to the present invention, the switch does not comprise one component but rather comprises a plurality of leaf springs which are arranged in layers on one another. Since the individual leaf springs can rub against one another and can also move in the longitudinal direction upon bending, the flexible rail strip from which the switch is composed is softer in the desired direction of movement, which permits more rapid switching times. The switching forces are also substantially smaller as a result. Owing to said construction in layers, it is also possible to layer different materials on one another, which permits a great deal of freedom with regard to rigidity, forces, minimum friction etc. In addition to spring steel, plastics, fiberglass, composite materials and carbon fiber materials are also possible materials.

In a second variant, the rail strip is constructed as a single part. It may be composed, for example, of composite materials, carbon fiber materials or fiberglass.

In a third variant, the starting point is basically that a core has wire coiled around it. As a result, the rail strip is substantially more elastic. However, there is also the possibility of producing the rail strip just from coiled spring wire without a core. The coiled wire can then be ground over, depending on requirements, such that neat surfaces and edges arise.

If an empty bottle is conveyed, it has proven advisable to cover the inner gripper with a pressure component, with the two side edges of the pressure component bearing linearly against the opening region of the bottle. Such a pressure component can be used for a multiplicity of different diameters of opening regions.

The pressure component is preferably assigned a counter holding spring on the outer gripper, said counter holding spring pressing the opening region of the bottle against the pressure component. This ensures that the object is securely held on the gripper vehicle.

If, by contrast, a full bottle is to be conveyed, the inner gripper has to be replaced by a further outer gripper. Otherwise, the same functional principle can be used.

A number of possibilities of a drive for the gripper vehicles are conceivable and covered by the invention. An interlocking drive is mentioned only by way of example. In this case, each vehicle has a driver pin which can be received in slots of a drive wheel. This enables the vehicles to be joined or separated but they can also be moved therewith. With the aid of the rotating drive wheel which has the slots at fixed distances, a multiplicity of vehicles can be pushed.

Another possibility resides in configuring the drive with a friction wheel. Owing to the consciously flat design of the back wall and head portion of the gripper vehicles according to the invention, it is possible to use such friction wheels as the drive, said friction wheels being able to move the vehicles along the rails. This can be of great importance in particular at locations at which the friction is greater than normal, for example at the location at which the conveying securing means is released. The use of the friction wheel also opens up the possibility of pushing a number of vehicles and of therefore bridging sections not having a dedicated drive. Furthermore, a backing-up option is provided to a certain extent.

In a further exemplary embodiment of the invention, for which protection is also sought separately, projections which bear at least partially against the object are to protrude from the guide means. Upon movement of the guide means, the objects are acted upon by the projections and moved at the same time.

In a preferred exemplary embodiment, the guide means is a round belt, wherein the latter has an internal fixed traction strand which is surrounded, for example, by a plastic casing. The projections are then located on and/or in said plastic casing. This may be, for example, a spiral spring made of steel.

Said round belt has the predominant advantage of being able to follow any desired profile of the rail in space. It can track any three-dimensional curve. In addition, the entire system is capable of providing a backing-up option, i.e. vehicles can stand still while the round belt continues to move. The belt simply slides along the object, i.e. the entire drive section does not have to be switched off if the vehicles have to be backed up. This is of great importance in terms of energy and in terms of the entire management of time, since only the backed-up objects have to be accelerated again rather than the entire drive section. The backing-up option also affords great advantages in the locations at which the objects have to be joined, since the required backing-up pressure can therefore be produced without additional apparatuses. The same also applies during pausing, for example before a switch, and here too the entire drive section does not have to be shut down.

Said round belt with or without a core with limited extensibility has a very hard, but also highly flexible outer skin which permits a three-dimensional guiding of the belt in space with tight bending radii and minimal bending work. This results in a very high degree of efficiency. If, for example, an object is clamped between two round belts, it can be moved. In this case, the spiral spring prevents excessive abrasion and therefore increases the service life of the entire conveying unit, since, owing to the spiral spring, the abrasion can be reduced to a minimum and the associated soiling is also lower, which is crucial particularly when conveying foodstuffs in the packaging industry.

In a further exemplary embodiment of the invention, a magnetic connection is produced between the object and guide means. In this case, the object can be connected directly to the guide means or a conveying vehicle or the like for the object can also be connected in between.

This means that the guide means is not coupled directly to the vehicle but rather preferably via a force produced by magnetism. The conveying of the vehicles is therefore configured in a highly flexible manner; in particular, the vehicles can also be backed up, which is urgently required in the case of larger systems. If, for example, a processing station briefly fails, the objects have to be paused before said processing station. In the case of the previously known systems, the only possible measure here is for the entire system to be shut down, and therefore even the objects located in processing stations which are still intact are not dealt with further. This is undesirable.

A permanent magnet which is arranged in or on the vehicle, or vice versa, interacts with the guide means which can be composed of ferromagnetic material or can be covered by ferromagnetic elements or a corresponding material.

In a further exemplary embodiment of the invention, a flat toothed belt is provided instead of a round belt. Although this has the advantage that a higher flat ferromagnetic density is produced than in the case of the round belt and therefore, for example, the conveying of the vehicles vertically upward is improved and also the braking performance is more favorable, the toothed belt has the disadvantage that it can follow a rail only in a plane, but not through three-dimensional curves. Therefore, the conveying three-dimensionally is not possible.

The same also applies to a steel band as a driving option.

The variations according to the invention of the apparatuses can move any objects. They are particularly preferably provided for moving preforms between an injection molding machine and a blow molding machine. Furthermore, they are preferably used for conveying PET bottles, with it being possible for the latter to be full or empty.

### BRIEF DESCRIPTION OF THE DRAWINGS

Further advantages, features and details of the invention emerge from the description below of preferred exemplary embodiments and with reference to the drawing, in which

FIG. 1 shows a detail from an apparatus according to the invention for conveying objects (not shown specifically);

FIG. 2 is a rear view of the detail of the apparatus according to FIG. 1;

FIG. 3 shows a larger detail from the apparatus according to the invention for conveying PET bottles during the transfer of said bottles;

FIG. 4 shows a detail from an apparatus according to the invention for conveying objects (not shown) with gripper vehicles coupled to one another;

FIG. 5 shows a rear view of an exemplary embodiment of a gripper vehicle;

FIGS. 6 and 7 show a partial section of a cross section from the apparatus according to FIG. 5 along line VI/VII-VI/VII in FIG. 5;

FIGS. 8 and 8a show details from the apparatus according to FIG. 1 with a further exemplary embodiment of a gripper vehicle and a filled bottle (partially illustrated) to be conveyed (only FIG. 8);

FIG. 9 shows a top view of the apparatus according to the invention according to FIG. 1 in the region of a switch;

FIG. 10 shows an enlarged, perspective illustration of a detail from a rail strip;

FIG. 11 shows a perspective view, illustrated on an enlarged scale, of a detail from a further exemplary embodiment of a rail strip;

FIG. 12 shows a perspective illustration of a detail of an apparatus according to the invention for conveying objects in the region of a drive;

FIG. 13 shows a perspective illustration of a further detail of an apparatus according to the invention for conveying objects in the region of a further exemplary embodiment of a drive;

FIG. 14 shows a side view of an apparatus for moving objects on a rail with a drive according to the invention assigned to a vehicle;

FIG. 15 shows an enlarged illustration of a detail from a drive element;

FIG. 16 shows a perspective view of a partial section of an apparatus for conveying PET bottles;

FIG. 17 shows a side view of a gripper vehicle on a rail according to FIG. 1, but with a further exemplary embodiment of a drive according to the invention;

FIG. 18 shows a side view of a gripper vehicle on a rail according to FIG. 1, but with a further exemplary embodiment of a drive according to the invention;

FIG. 19 shows a perspective view of a further exemplary embodiment of an apparatus according to the invention for moving preforms;

FIG. 20 shows a perspective view of a further exemplary embodiment of an apparatus for moving conveying slides.

### DETAILED DESCRIPTION

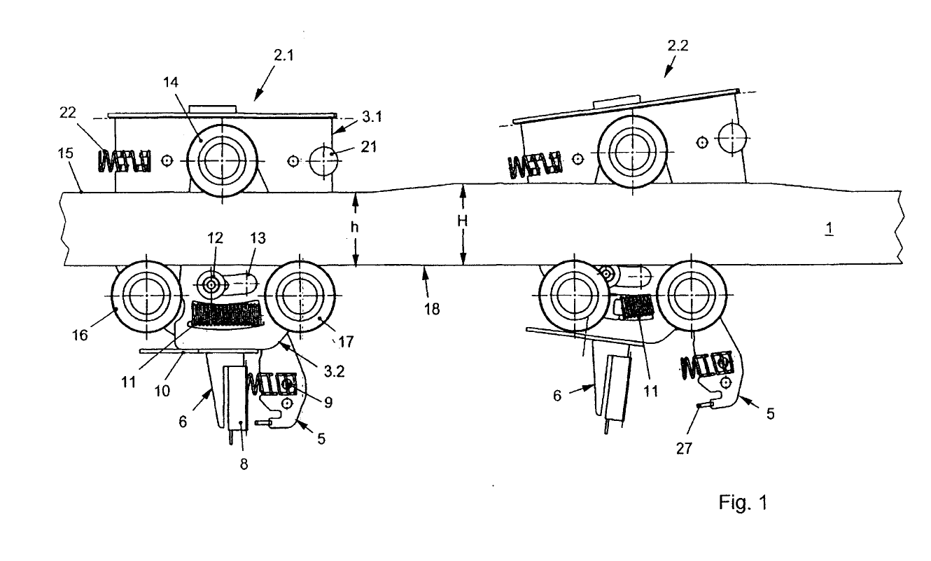

FIG. 1 illustrates a rail 1 along which two gripper vehicles 2.1 and 2.2 run. Since the two gripper vehicles 2.1 and 2.2 are of identical design, only one thereof is described below.

Each gripper vehicle 2.1, 2.2 has two gripping arms 3.1 and 3.2 which are connected to each other via a rotary spindle 4. Upon rotation about the rotary spindle 4, the gripping arms 3.1 and 3.2 can open in the manner of a pair of scissors, with an outer gripper 5 separating from an inner gripper 6, as can be seen in the case of the gripper vehicle 2.2.

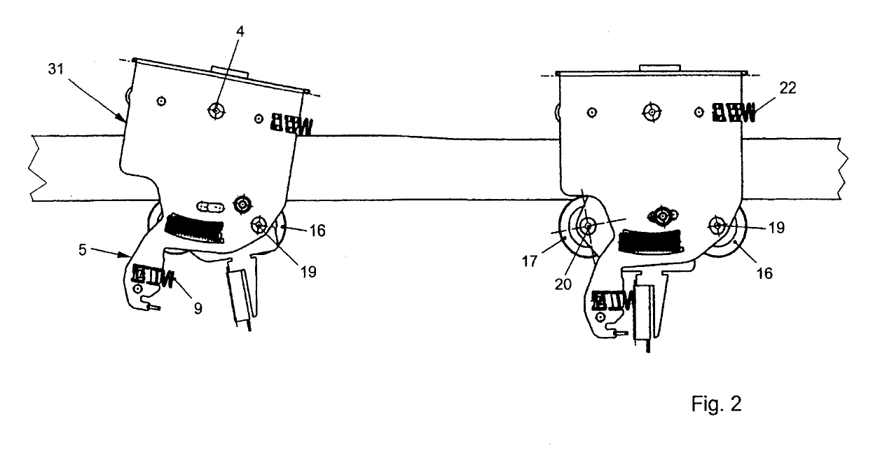

The outer gripper 5 is preferably connected integrally together with a back wall 7 to the gripping arm 3.1, with the latter also being referred to as the basic limb, since it is composed essentially of flat material, as can be seen in particular in FIG. 2.

The inner gripper 6 is also connected at least partially integrally to the gripping arm 3.2, with both the inner gripper and gripping arm being produced substantially likewise from a flat material, for which reason said gripping arm is also referred to as the scissor limb. A pressure component 8 which interacts with a counter holding spring 9 on the outer gripper 5 is also located on the inner gripper 6. Furthermore, the inner gripper 6 is assigned a cover 10.

A closing spring 11 which assists in guiding the inner gripper 6 and outer gripper 5 together is inserted into corresponding recesses between the basic limb 3.1 and scissor limb 3.2. Furthermore, the guidance of the basic limb 3.1 and scissor limb 3.2 is also ensured by means of a bolt head 12 which is connected to the basic limb 3.1 via a bolt (not shown) which reaches through a curved elongated hole 13 in the scissor limb 3.2, with the bolt head 12 engaging over the elongated hole.

A profiled roller 14 which runs along an upper edge 15 of the rail 1 sits on the rotary spindle 4. Said roller 14 interacts with two further profiled rollers 16 and 17 which each run along a lower edge 18 of the rail 1. In this case, a rotary spindle 19 of the roller 16 sits in the basic limb 3.1 while a rotary spindle 20 of the roller 17 is connected to the scissor limb 3.2. The rotary spindles 19 and 20 form a triangle together with the rotary spindle 4 such that the distance between the rotary spindles 19 and 20 can be changed, as described further on.

Above the rail 1, a coupling magnet 21 and a coupling spring 22 are also located on the basic limb 3.1.

The rail 1 usually has a height h which is increased to a height H in regions in which the gripping arms 3.1 and 3.2 are to be opened.

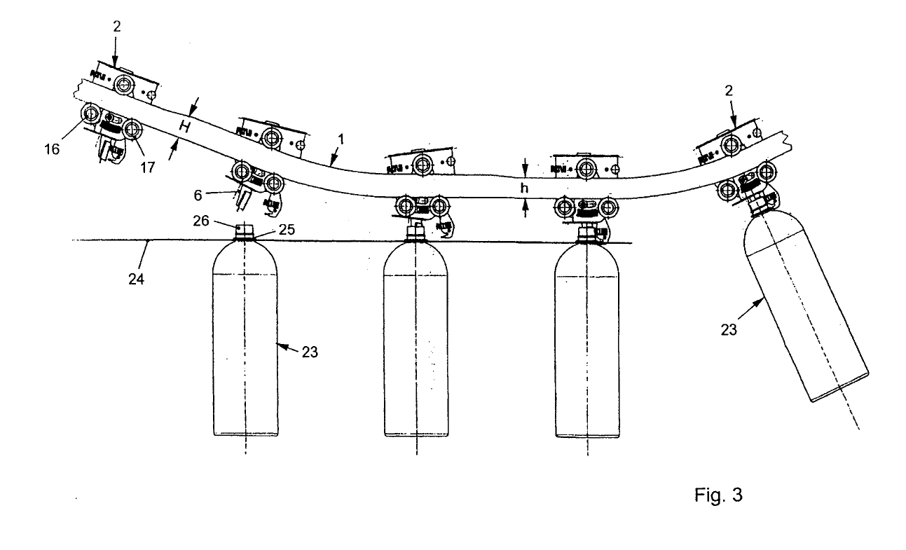

The manner in which the present invention operates will be described in more detail in particular in conjunction with FIG. 3:

The gripper vehicles 2 run along the rail 1 by means of the rollers 14, 16 and 17, with the gripping arms 3.1 and 3.2 normally being closed. As soon as the rail enters the vicinity of a transfer station (shown in FIG. 3), the customary height h of the rail 1 is increased to the height H. The effect of this is that the distance between the two rotary spindles 19 and 20 of the rollers 16 and 17 is reduced. This results in opening of the gripping arms 3.1 and 3.2 and in the outer gripper 5 moving away from the inner gripper 6, to be precise counter to the pressure of the closing spring 11.

In the transfer station shown in FIG. 3, the objects 23, for example PET bottles, are clocked by blow molding machine grippers and guided along sliding planes 24, the sliding planes 24 comprising, for example two rails which run parallel to each other and engage below a neck ring 25 on the object 23.

On the rail 1 immediately after the blow molding machine, the gripper vehicle 2 is guided from above toward the sliding plane 24 such that the inner gripper 6 can enter an opening 26 in the object 23 which is still clocked by the blow molding machine grippers. The height of the rail 1 is subsequently reduced again to the height h, which results in the distance between the two rotary spindles 19 and 20 of the rollers 16 and 17 being able to expand again such that the gripping arms 3.1 and 3.2 close, with the outer gripper 5 engaging below the neck ring 25 by means of a tooth 27 and the counter holding spring 9 pressing an opening region of the object against the pressure component 8. Said pressure component 8 is likewise of flat design toward the counter holding spring 9 such that it bears only by means of its two border edges against an inner opening region of the object 23. That is to say, there is two-line contact, and therefore said pressure component can take account of very different opening widths of the objects 23.

In FIG. 3, the final illustration of a gripper vehicle 2 with an object 23, shows that the gripper vehicle 2 has grasped the object 23 and removed it from the sliding plane 24. A transfer to other sliding planes or grippers (not shown) takes place in the same manner.

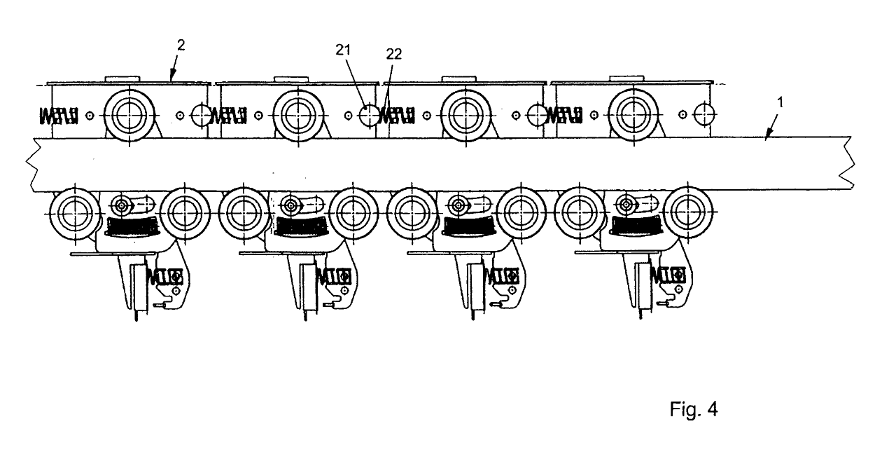

FIG. 4 illustrates that a plurality of gripper vehicles 2 can also run along the rail 1 in convoy. By this means, vehicle arrangements can arise. For the coupling together, the coupling magnet 21 and the coupling spring 22 interact, with the latter also having the task of cushioning the impact upon collision of two gripper vehicles 2. This is applicable in particular when a back-up arrangement arises.

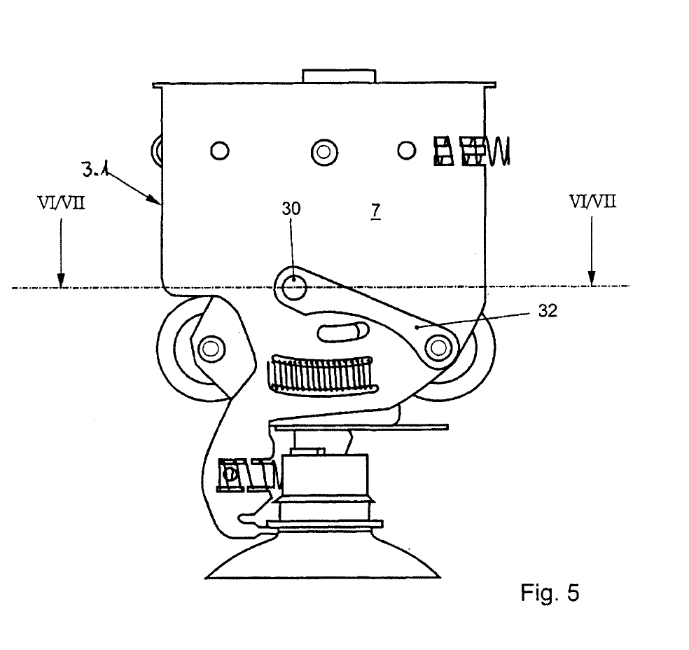

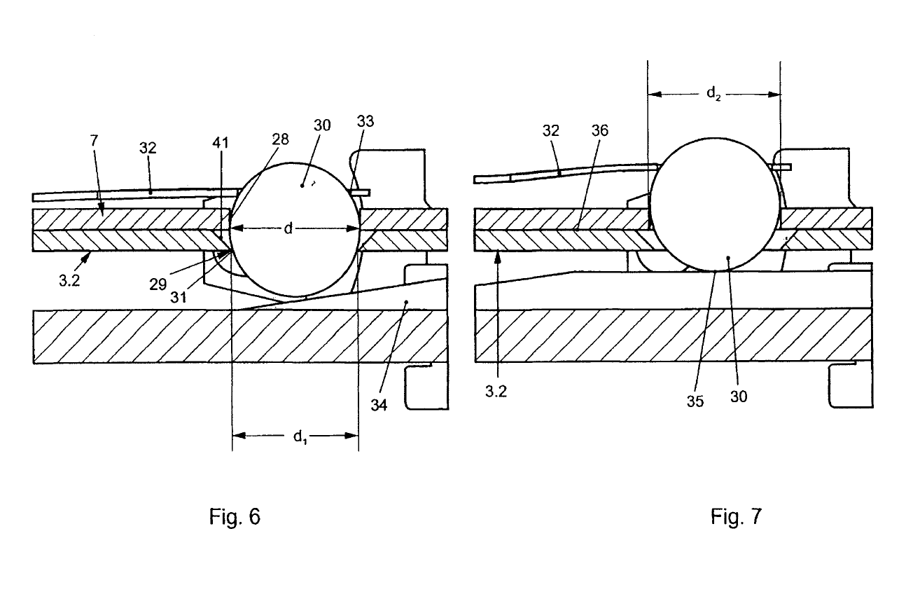

A further essential element of the present invention is concerned with a conveying securing means, as illustrated in FIGS. 5 to 7. The conveying securing means has to be configured in such a manner that no opening movements can be carried out without it releasing the basic limb 3.1 and scissor limb 3.2. The conveying securing means also has to be releasable automatically and easily. For this purpose, a round opening 28 is formed in the back wall 7 of the basic limb 3.1, said opening, in the securing position, as illustrated in FIG. 6, being congruent with an opening 29 in the scissor limb 3.1. Said opening 29 has a diameter d₁ which is smaller than a diameter d of a ball 30 while the opening 28 has a diameter d₂ which is slightly larger than the diameter d of the ball 30. Furthermore, the opening 29 has a bevel 41 which enlarges the opening 29 toward the back wall 7. By this means, a tangential edge 31 is produced in the opening 29 toward the ball 30.

Furthermore, the ball 30 is held at least in the opening 28 in the back wall 7 by a leaf spring 32, with the leaf spring 32 having a receiving opening 33 for the ball 30 with a smaller diameter than that of the ball 30.

The manner in which the invention operates is as follows:

In the securing position, the ball 30 sits in the openings 28 and 29 under the pressure of the leaf spring 32. It cannot drop out of the opening 29, since said opening has a smaller diameter d₁ in the region of the tangential edge 31 than the diameter d of the ball 30.

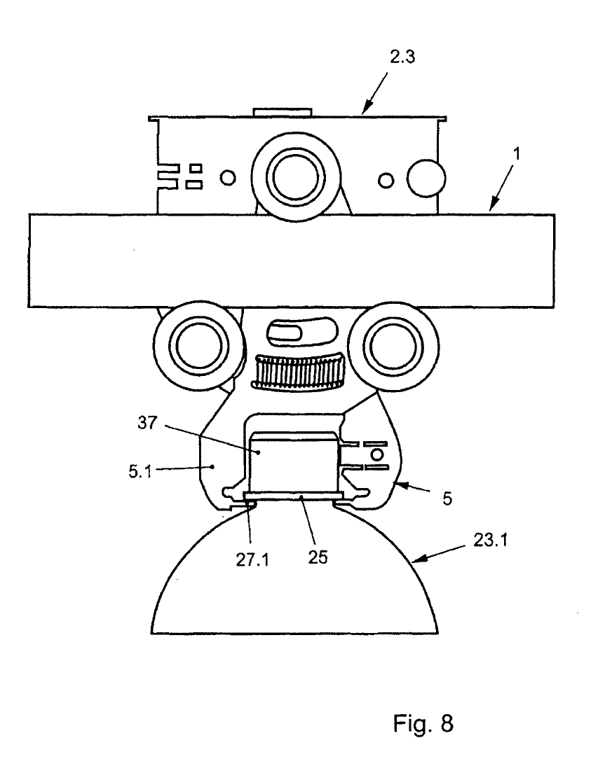

If the conveying securing means is to be released, in particular in the transfer region of objects according to FIG. 3, a rising switching guide way 34 is provided on the rail 1, said switching guide way causing the ball 30, as shown in FIG. 7, to be pressed out of the opening 29 and also partially out of the opening 28. This takes place counter to the counterpressure of the leaf spring 32.

If the gripping arms 3.1 and 3.2 are then to be opened, said two gripping arms move relative to each other such that the tangential edge 31 of the opening 29 strikes against the ball 30. However, because of the design as a tangential edge, said tangential edge presses the ball 30 even further counter to the leaf spring 32 and finally presses it out of the opening 29 such that an apex 35 of the ball 30 then sits on an inner surface 36 of the scissor limb 3.2. By this means, the conveying securing means is released and the two gripping arms 3.1 and 3.2 can open and close. For the closure, the opening 29 then comes again to coincide with the opening 28, as a result of which the ball 30 is first of all pressed onto the switching guide way 34 and then runs along the latter as far as the end thereof, with the ball 30 then bearing snuggly again against the tangential edge 31.

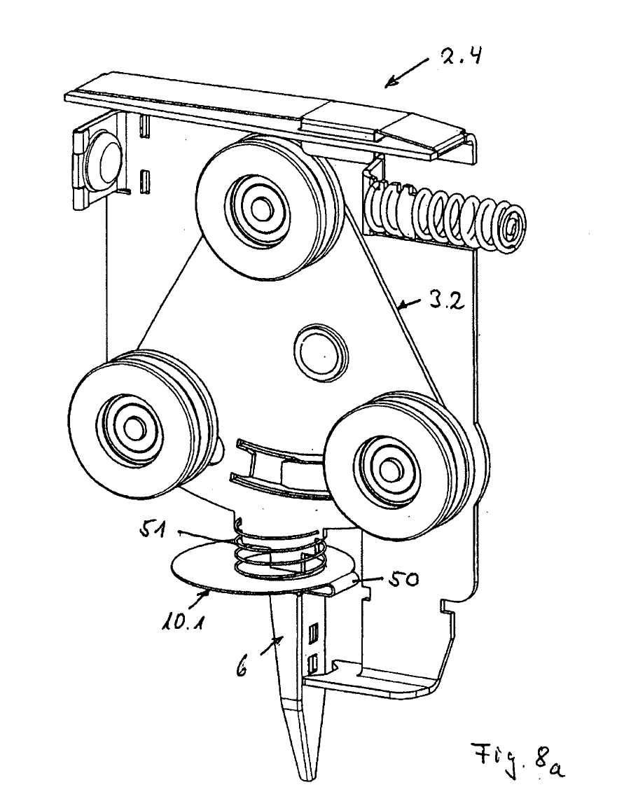

FIG. 8 shows a further exemplary embodiment of a gripper vehicle 2.3. The latter serves to convey a filled object 23.1, the opening of which is closed by a cap 37. It is provided here that the inner gripper is replaced by a second outer gripper 5.1 which interacts with the first outer gripper 5, with the outer gripper 5.1 also engaging under the neck ring 25 by means of a tooth 27.1.

FIG. 8a furthermore illustrates a gripper vehicle 2.4 in which a cover 10.1 is connected to the inner gripper 6 via a spring loop 50. Said cover 10.1 is supported against the gripping arm 3.2 via a helical spring 51. By this means, the cover 10.1 is mounted resiliently and can yield, for example, to a pressure exerted by an opening rim of a bottle.

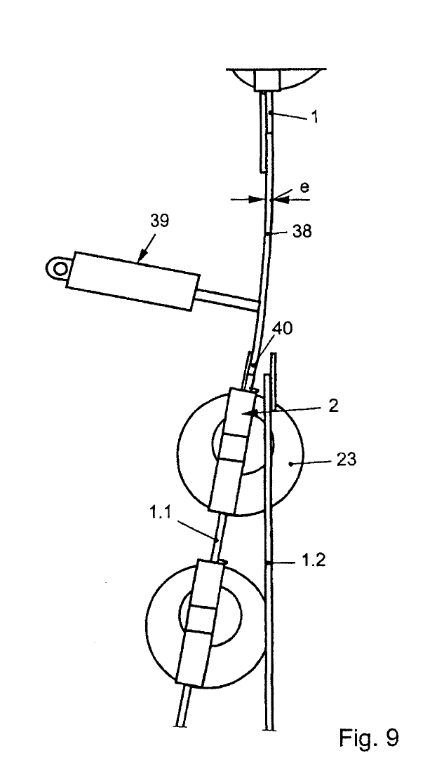

The guiding according to the invention of the gripper vehicles 2 on the rail 1 also permits a particularly advantageous configuration of a switch as shown in FIG. 9. The corresponding vehicles can be transferred there after the rail 1 to a further rail section 1.1 or 1.2. For this purpose, a rail strip 38 is connected to the rail 1, said rail strip being acted upon by a simple pneumatic cylinder 39 or electric lifting magnet. Of course, other drive means for the rail strip 38 are also conceivable here. Said pneumatic cylinder 39 moves the rail strip 38 or the free end 40 thereof into contact either with the rail guide 1.1 or 1.2, depending on requirements.

So that the transfer takes place as uniformly as possible, the rail 1 and rail guides 1.1 and 1.2 are designed to be reduced in thickness in the transfer region while a thickness e of the rail strip 38 corresponds to the thickness of the region of reduced thickness.

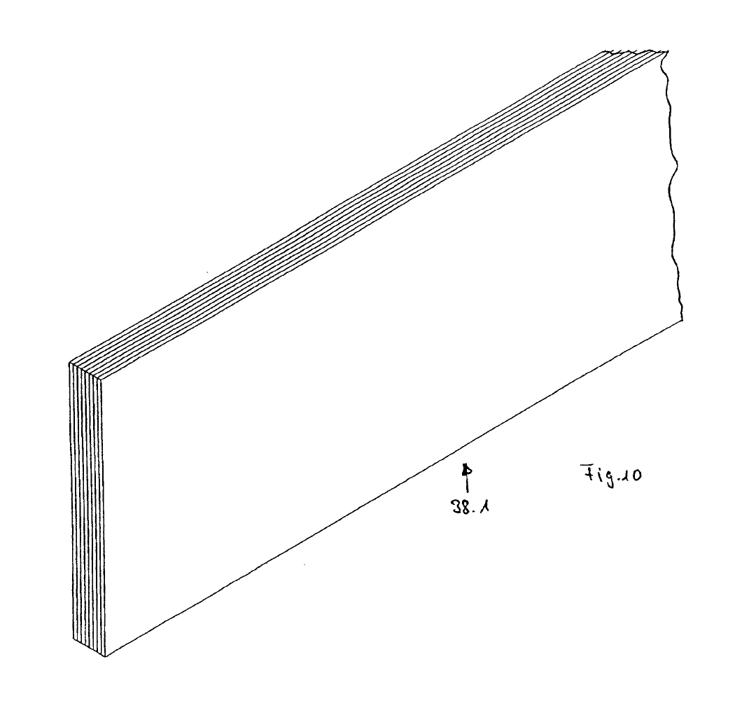

Various options are provided for the construction of the rail strip 38. FIG. 10 shows that the rail strip is not composed of one component but rather of a plurality of leaf springs arranged in layers. Owing to said construction in layers, it is also possible to layer different materials on one another, which permits a great amount of freedom with regard to rigidity, forces, minimum friction etc. In addition to spring steel, plastic, fiberglass, composite materials and carbon fiber materials are also possible materials.

In a second variant, which is not illustrated, however, the rail strips 38 can also be constructed as a single part. Fiberglass, composite materials and carbon fiber materials are conceivable here as possible materials.

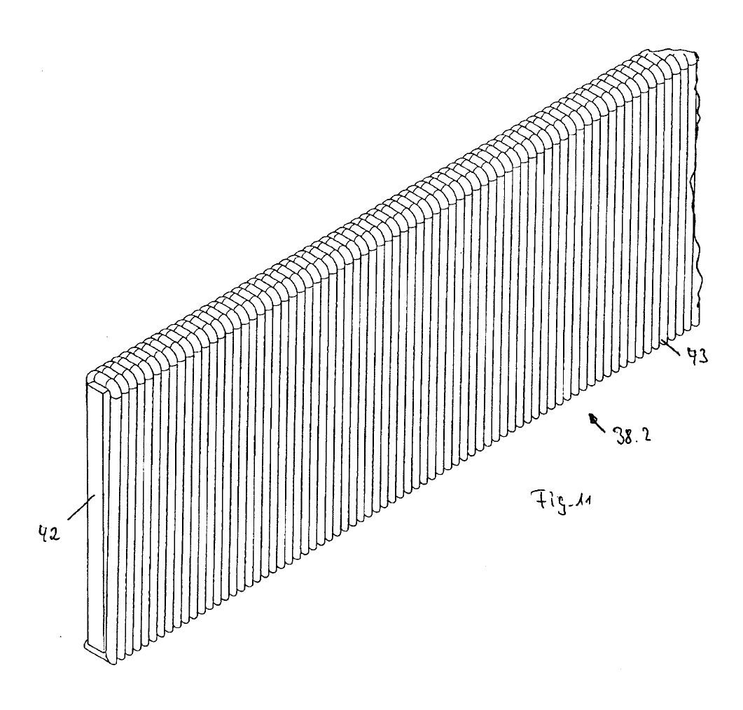

In a third variant according to FIG. 11, a rail strip 38.2 comprises a core 42 which has wire 43 wound around it. Said rail strip 38.2 is extremely elastic. There is also the option of not using a core but rather of producing the rail strip just from coiled spring wire. Furthermore, the coiled wire can also be ground over, depending on requirements, such that neat surfaces and edges are produced.

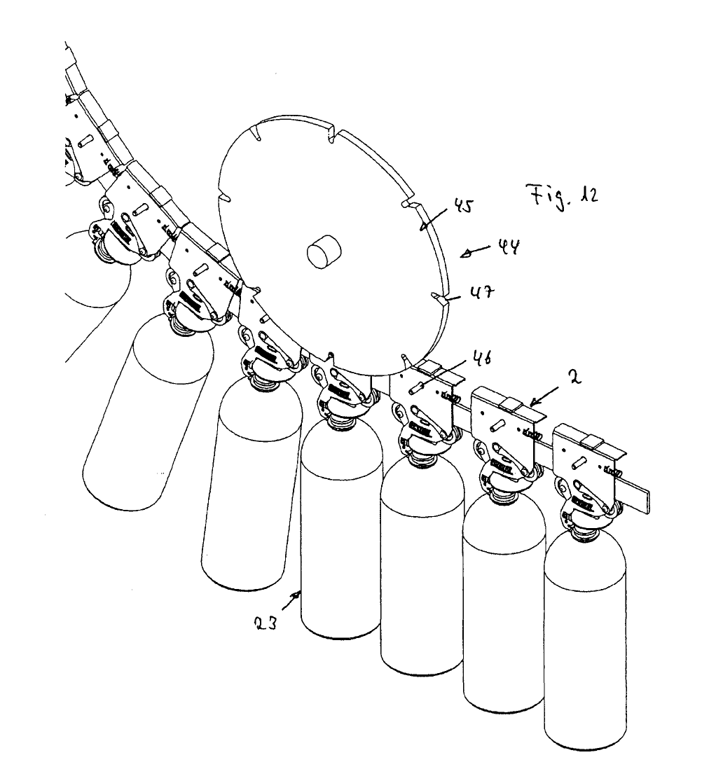

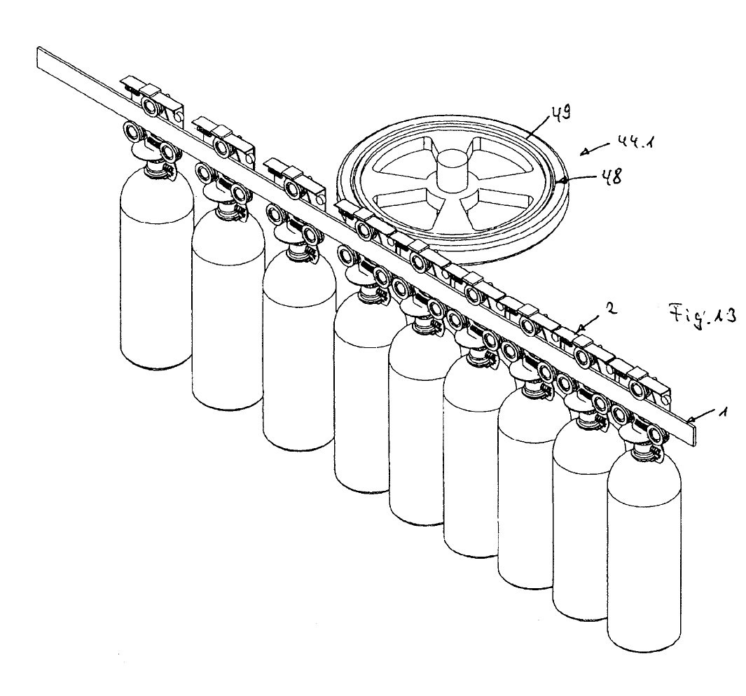

A large number of options are also conceivable for a drive of the gripper vehicles 2. Two options are illustrated in FIGS. 12 and 13 merely by way of example. In the case of the drive 44 according to FIG. 12, a drive wheel 45 is in interlocking engagement with driver pins 46 on the gripper vehicle 2. Said driver pins 46 are carried along by slots 47 in the circumference of the drive wheel 45. In another exemplary embodiment of a drive 44.1 according to FIG. 13, the vehicles 2 are assigned a friction wheel 48. Said friction wheel 48 is covered by a ring 49 made of material with frictional resistance.

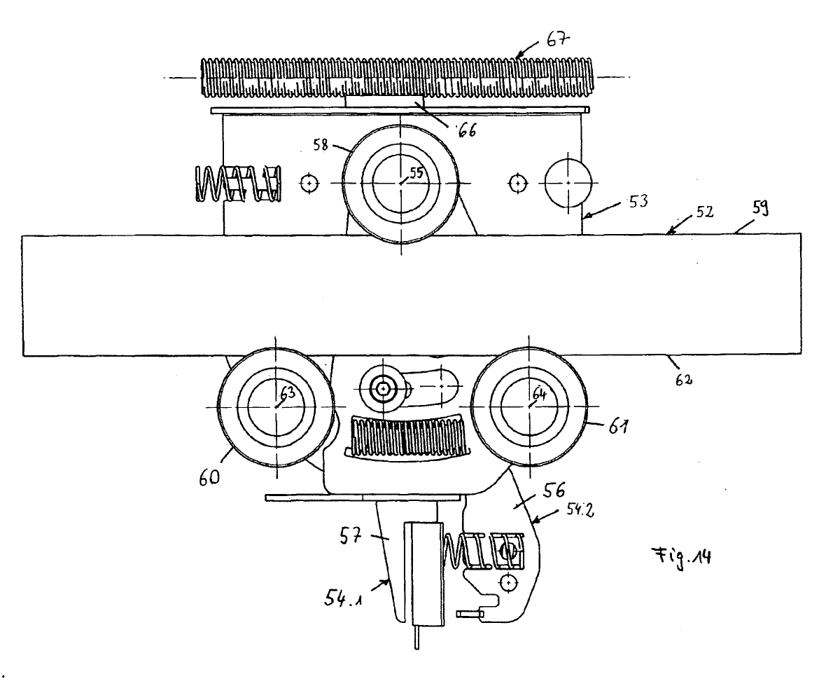

A further exemplary embodiment of the invention according to FIG. 14 illustrates a rail 52 along which a gripper vehicle 53 runs. Said gripper vehicle 53 has two gripping arms 54.1 and 54.2 which are connected to each other via a rotary spindle 55. Upon rotation about the rotary spindle 55, the gripping arms 54.1 and 54.2 can open in the manner of a pair of scissors, with an outer gripper 56 being separated from an inner gripper 57.

A roller 58 which runs along an upper edge 59 of the rail 52 sits on the rotary spindle 55. Said roller 58 interacts with two further rollers 16 and 17 which each run along a lower edge 62 of the rail 52. In this case, a rotary spindle 63 of the roller 60 sits in the gripping arm 3.1 while a rotary spindle 64 of the roller 61 is connected to the gripping arm 3.2. The rotary spindles 19 and 20 form a triangle together with the rotary spindle 55, with the distance between the rotary spindle 63 and hypotenuse 20 being changeable in its length. By this means, the gripping arms 54.1 and 54.2 can be opened or closed.

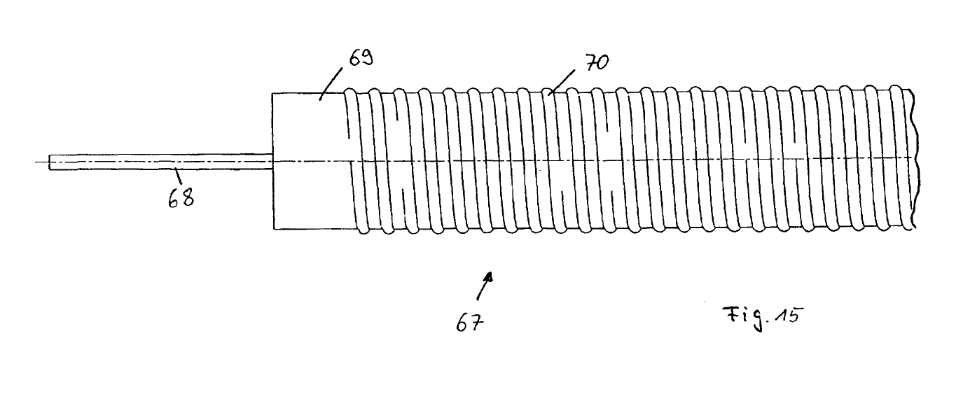

A permanent magnet 66 which interacts with a round belt 67 for driving the gripper vehicle 2 rests on the gripper vehicle 53. A detail of said round belt 51 is shown on an enlarged scale in FIG. 15. The round belt 67 is constructed in three parts. A traction strand 68, for example made of metal or Kevlar, is located in the interior as a core. A plastic casing 69 is provided around said traction strand 68, said plastic casing having a spiral spring 70 made of a ferromagnetic material looped around it. Said spiral spring can either be pulled over the plastic casing or else cast therein.

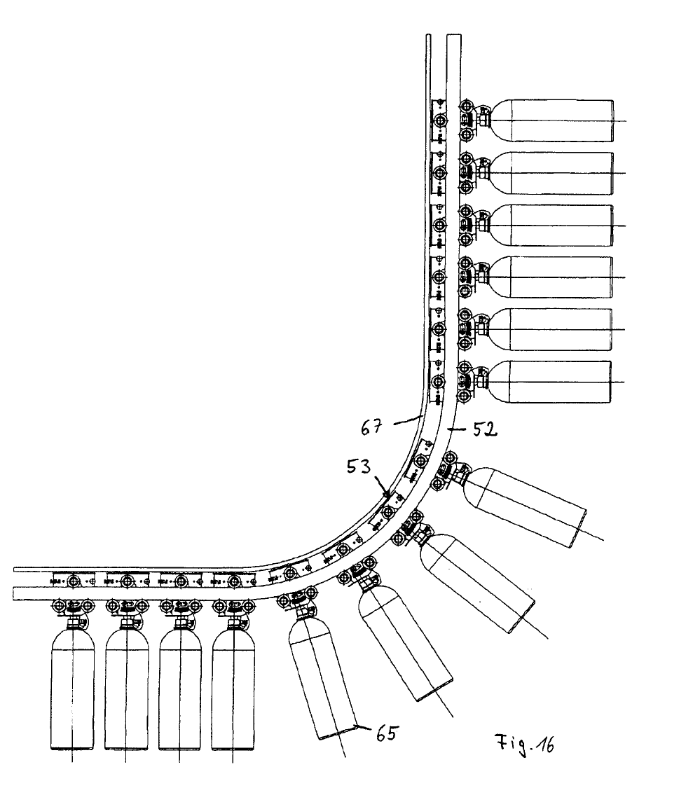

The manner of operation can also be readily seen in FIG. 16. A plurality of gripper vehicles 53 is arranged there on a rail 52 which leads upward. Said gripper vehicles are conveying objects 23, namely PET bottles.

The round belt 67 also follows the course of the rail 52, with it being apparent that the PET bottles 23 can be backed up on the rail 52 before and after the curvature. The round belt 67 enables gripper vehicles 2 to be carried along in any desired three-dimensional arrangement of the rail 52.

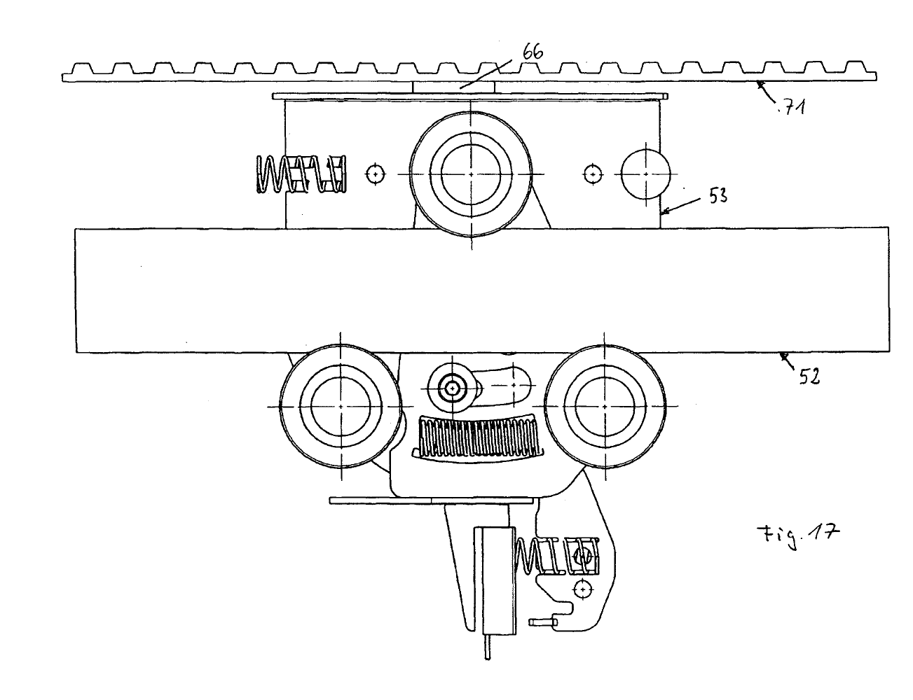

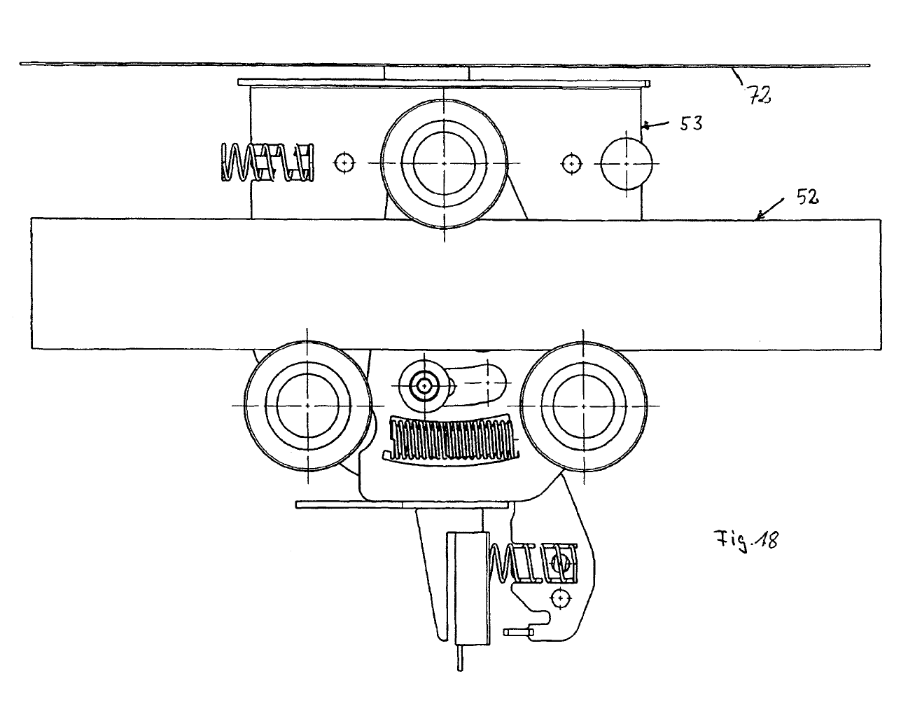

In another exemplary embodiment of the present invention according to FIG. 17, the round belt 67 is replaced by a toothed belt 71. Ferromagnetic elements (not shown specifically) are located in said toothed belt and can be used to produce a greater ferromagnetic density than in the case of the round belt. This has advantages during the conveying of gripper vehicles vertically upward or during braking, but three-dimensional curves cannot be traveled around using a toothed belt 71. The same also applies to a steel band 72 as indicated in FIG. 18.

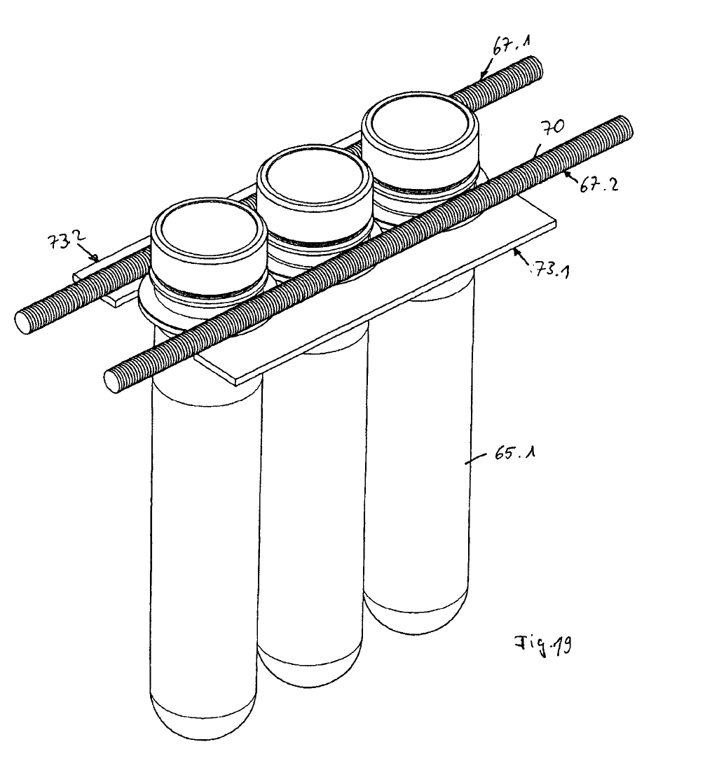

According to FIG. 19, preforms 65.1 are moved along the guide rails 73.1 and 73.2 by two round belts 67.1 and 67.2 as described for FIG. 15. In this case, the round belt 67.1 or 67.2 does not act magnetically, but rather frictionally. The two round belts 67.1 and 67.2 act upon the preforms 65.1 in the neck region thereof. The preforms 65.1 are carried frictionally along the guide rails 73.1 and 73.2 by the coils of the spiral spring 70.

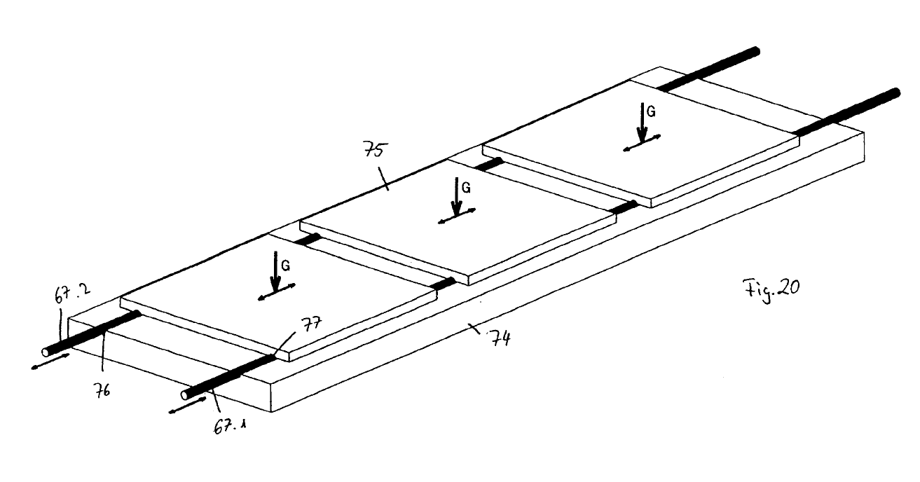

According to FIG. 20, a plurality of slides 75 are to be moved along a base 74. This likewise takes place by means of the round belts 67.1 and 67.2 which are guided in corresponding grooves 76 in the base 74. Furthermore, corresponding insertion grooves 77 are also formed in the lower side of the slides 75. If the round belts 67.1 and 67.2 are moved along the double arrows, they take the slides 75 with them. In this case, this takes place rather in an interlocking manner.

1-51. (canceled)

52. A method for conveying an object comprising holding an object between two grippers (5, 6) by a scissors-like opening movement of the two gripping arms (3.1, 3.2) of a gripper vehicle (2, 2.1, 2.2, 2.3, 2.4) while moving the gripper vehicle along a rail (1, 1.1, 1.2), wherein the scissors-like opening movement is brought about by the rail (1).

53. The method as claimed in claim 52, including changing a height (h, H) of the rail (1) for opening movement of the two gripping arms (3.1, 3.2).

54. The method as claimed in claim 52, wherein an inner gripper (6) of one gripping arm (3.2) is inserted into an opening (26) in the object (23) while an outer gripper (5) of the other gripping arm (3.1) engages below a neck ring (25).

55. The method as claimed in claim 54, wherein the outer gripper (5) which engages below the neck ring (25) presses the object (23) against the inner gripper (6).

56. The method as claimed in claim 52, including preventing an opening movement of the two gripping arms (3.1, 3.2) during the conveying of the object (23, 23.1).

57. The method as claimed in claim 52, including a plurality of gripper vehicles wherein each gripper vehicle (2, 2.1, 2.2, 2.3, 2.4) is identified.

58. The method as claimed in claim 57, wherein the plurality of gripper vehicles (2) can be coupled together.

59. The method as claimed in claim 54, wherein the opening (26) in the object (23) is covered during conveying.

60. An apparatus for conveying light objects comprising a gripper vehicle (2, 2.1, 2.2, 2.3, 2.4) which holds the object (23, 23.1) and runs along a rail (1, 1.1, 1.2), wherein the gripper vehicle (2, 2.1, 2.2, 2.3, 2.4) has two gripping arms (3.1, 3.2) having a gripper (5, 6) arranged on each gripping arm (3.1, 3.2), the two gripping arms (3.1, 3.2) being connected to each other in the manner of a pair of scissors via a rotary spindle (4), each gripping arm (3.1, 3.2) is assigned at least two rollers, wherein one roller (14) runs along an upper edge (15) of the rail (1) and the other roller (16, 17) runs along a lower edge (18) of the rail (1).

61. The apparatus as claimed in claim 60, wherein the two gripping arms (3.1, 3.2) are supported against each other via a closing spring (11).

62. The apparatus as claimed in claim 60, wherein the two gripping arms are designed as limbs, wherein one gripping arm serving as a basic limb (3.1) and the other gripping arm serving as a scissor limb (3.2).

63. The apparatus as claimed in claim 62, wherein an outer gripper (5) is located on the basic limb (3.1) and an inner gripper (6) is located on the scissor limb (3.2).

64. The apparatus as claimed in claim 63, wherein the roller which runs along the upper edge (15) of the rail (1) sits on a rotary spindle (4) of the basic limb (3.1) and scissor limb (3.2).

65. The apparatus as claimed in claim 64, wherein one roller (16) running along the lower edge (18) is arranged on the basic limb (3.1) and another roller (17) is arranged on the scissor limb (3.2).

66. The apparatus as claimed in claim 64, wherein the rotary spindle (4, 19, 20) has three rollers (14, 16, 17) which form a triangle with one another.

67. The apparatus as claimed in claim 60, wherein the rail (1) has regions of differing height (h, H).

68. The apparatus as claimed in claim 67, wherein the rail (1) has a greater height (H) in regions in which the gripper vehicle (2, 2.1, 2.2, 2.3, 2.4) receives and delivers objects (23, 23.1) than in other regions.

69. The apparatus as claimed in claim 68, wherein the inner gripper (6) has a pressure component (8) toward the opening wall of the object (23) and the outer gripper (5) has a counter holding spring (9).

70. The apparatus as claimed in claim 60, wherein an optionally sprung cover (10, 10.1) or a stopper is arranged on the inner gripper (6) for at least partially closing an opening (26).

71. The apparatus as claimed in claim 58, wherein each gripper vehicle (2, 2.1, 2.2, 2.3, 2.4) has a coupling element (21, 22) for connection to another gripper vehicle.

72. The apparatus as claimed in claim 71, wherein the gripper vehicle (2, 2.1, 2.2, 2.3, 2.4) has a coupling magnet (21) which is assigned a coupling spring or a ferromagnetic element (22).

73. The apparatus as claimed in claim 60, wherein the two gripping arms (3.1, 3.2) are assigned a conveying securing means.

74. The apparatus as claimed in claim 73, wherein the conveying securing means has a ball (30) which, in a securing position, sits in two coaxial or congruent openings (28, 29) in the two gripping arms (3.1, 3.2) and is held there by a securing spring (32).

75. The apparatus as claimed in claim 74, wherein, in order to cancel the securing, the ball (30) is assigned a switching guide way (34) on the rail (1).

76. The apparatus as claimed in claim 73, further comprising at least one opening (29) in the gripping arms in which the ball (30) sits, has a bevel (41) widening the opening, and the opening has a tangential edge (31), a diameter (d₁) of the opening (29) being smaller in the region of the tangential edge (31) than a diameter (d) of the ball (30).

77. The apparatus as claimed in claim 60, wherein the gripper vehicle (2, 2.1, 2.2, 2.3, 2.4) is assigned an identification feature.

78. The apparatus as claimed in claim 77, wherein the identification feature is at least one of a barcode, a data matrix code, and an electric chip provided on the gripper vehicle.

79. The apparatus as claimed in claim 60, wherein an outer gripper (5, 5.1) engages below a neck ring (25) of the object.

80. The apparatus as claimed in claim 60, wherein a rail strip (38, 38.1, 38.2) is connected between the rail (1) and two rail guides (1.1, 1.2) as a switch.

81. The apparatus as claimed in claim 80, wherein the rail strip (38, 38.1, 38.2) has a thickness (e) which corresponds approximately to a tapering of a thickness of the rail (1) or of the rail guides (1.1, 1.2) in the transition region toward the switch.

82. The apparatus as claimed in claim 80, wherein the rail strip (38.1) comprises a layering of different leaf springs.

83. The apparatus as claimed in claim 82, wherein the leaf springs are composed of one of carbon, spring steel, fiberglass, composite materials and carbon fiber materials.

84. The apparatus as claimed in claim 80, wherein the rail strip (38.2) is composed of a coiled spring wire (43).

85. The apparatus as claimed in claim 84, wherein the spring wire (43) surrounds a core (42).

86. The apparatus as claimed in claim 57, wherein the gripper vehicles (2, 2.1, 2.2, 2.3, 2.4) are assigned a drive (44, 44.1).

87. The apparatus as claimed in claim 86, wherein the drive (44) is an interlocking drive.

88. The apparatus as claimed in claim 87, wherein the drive comprises a drive wheel (45) having slots (47) which interact with driver pins (46).

89. The apparatus as claimed in claim 86, wherein the drive has a friction wheel (48).

90. An apparatus for moving an object (53, 65, 65.1) comprises a moving guide (67, 67.1, 67.2, 71, 72) which takes an object (53, 65, 65.1) with it, the guide has projections (70) which bear at least partially against the object (53, 65, 65.1) and protrude from the guide (67, 67.1, 67.2).

91. An apparatus for moving an object (53, 65, 65.1) comprises a moving guide (67, 67.1, 67.2, 71, 72) which takes the object (53, 65, 65.1) with it, the guide has means for producing a magnetic connection between the object (53, 65, 65.1) and guide (67, 67.1, 67.2, 71, 72).

92. The apparatus as claimed in claim 91, wherein at least one permanent magnet is arranged on the object (53, 65, 65.1) or on the guide (67, 71, 72), said permanent magnet interacting with a ferromagnetic material on the object (53, 65, 65.1) or the guide (67, 71, 72).

93. The apparatus as claimed in claim 90, wherein the guide (67, 67.1, 67.2, 71, 72) extends linearly and is moveable in all directions.

94. The apparatus as claimed in claim 93, wherein the guide is a round belt (67, 67.1, 67.2).

95. The apparatus as claimed in claim 94, wherein a spiral spring (70) is cast into part of a casing (69).

96. The apparatus as claimed in claim 95, wherein a traction strand (68) is formed from a plastic with limited extensibility.

97. The apparatus as claimed in claim 95, wherein the spiral spring (70) is made of steel.

98. The apparatus as claimed in claim 95, wherein the guide is a toothed belt (71).

99. The apparatus as claimed in claim 98, wherein ferromagnetic elements are arranged in an interior of the toothed belt.

100. The apparatus as claimed in claim 96, wherein the traction strand is a steel band (72).

101. The apparatus as claimed in claim 90, wherein the object comprises a preform (65.1) and the guide (67.1, 67.2) acts upon the preform from both sides in a neck region.

102. The apparatus as claimed in claim 90, wherein the object (65, 65.1) is arranged on a slide which is moved by the guide (67, 67.1, 67.2, 71, 72).
